(19) United States
(12) Patent Application Publication
(10) Pub. No.: US 2019/0158232 A1
(43) Pub. Date: May 23, 2019

(54) MOBILE APPARATUS AND RANDOM ACCESS METHOD THEROF

(71) Applicant: Institute For Information Industry, Taipei (TW)

(72) Inventors: Chun-Yen HSU, Taipei City (TW); Hsien-Tsung HSU, Taipei City (TW)

(21) Appl. No.: 15/831,279

(22) Filed: Dec. 4, 2017

(30) Foreign Application Priority Data
Nov. 23, 2017 (TW) 106140752

(51) Int. Cl. H04L 1/18; H04W 74/08; H04W 72/12; H04W 74/00

(52) U.S. Cl. CPC H04L 1/1854; H04W 74/0833; H04L 1/1864; H04W 74/002; H04W 72/1205

(57) ABSTRACT

A mobile apparatus and a random access method thereof are provided. The mobile apparatus transmits at least two random access preambles to a base station, and receives at least two random access responses corresponding to the at least two random access preambles from the base station. The mobile apparatus selects a first random access response from the at least two random access responses. The first random access response indicates a first network resource block. The mobile apparatus transmits a wireless message to the base station via the first network resource block.

### PRIORITY

This application claims priority to Taiwan Patent Application No. 106140752 filed on Nov. 23, 2017, which is hereby incorporated by reference in its entirety.

### FIELD

The present invention relates to a mobile apparatus and a random access method thereof. More particularly, a mobile apparatus and a random access method thereof according to the present invention can increase the probability of successful random access.

### BACKGROUND

A network random access procedure is a technology that is mainly initiated by a mobile station to request network resources from a base station for performing data transmission. Specifically, in the random access procedure, the mobile station transmits a single random access preamble to the base station, and the base station transmits a random access response back to the mobile station after receiving the random access preamble, wherein the random access response carries usage instruction of network resource blocks.

Next, the mobile station accordingly transmits a wireless message (e.g., Msg3) to the base station via a specified network resource block. The base station transmits a response signal to the mobile station if it successfully decodes the message so that the mobile station knows the random access with the base station is successful.

However, if two or more mobile stations transmit the same random access preamble to the base station via the same network resource, the base station will also transmit one random access response back to these mobile stations. Thus these mobile stations will receive the same random access response carrying usage instruction of network resource blocks.

Accordingly, these mobile stations will respectively transmit their wireless messages to the base station via the same specified network resource block. In this case, collision will occur among the messages transmitted by these mobile stations. This makes the base station unable to decode the relevant messages correctly and thus the base station transmits response signals indicating reception failure back to these mobile stations.

To combat poor channel quality, these mobile stations will retransmit their respective wireless messages for a configured number of times. But as all these mobile stations recognized the same random access response, collision among these wireless messages will occurred continuously. When the configured number of retransmit of the wireless message is reached, the mobile station consider the random access fails. Moreover, if there are a large number of mobile stations in the network environment, then the probability of successfully performing the random access procedure will be decreased remarkably.

Accordingly, an urgent need exists in the art to improve the aforesaid problems so as to improve the probability of successfully performing the random access and improve the utilization efficiency of the overall network resource.

### SUMMARY

The disclosure includes a random access method, which may comprise: transmitting, by the mobile apparatus, at least two random access preambles to a base station; receiving, by the mobile apparatus, at least two random access responses corresponding to the at least two random access preambles from the base station; selecting, by the mobile apparatus, a first random access response from the at least two random access responses, wherein the first random access response indicates a first network resource block; and transmitting, by the mobile apparatus, a wireless message to the base station via the first network resource block.

The disclosure also includes a mobile apparatus which comprises a processor and a transceiver. The processor may be configured to: transmit at least two random access preambles to a base station through the transceiver; receive at least two random access responses corresponding to the at least two random access preambles from the base station through the transceiver; select a first random access response from the at least two random access responses, wherein the first random access response indicates a first network resource block; and transmit a wireless message to the base station via the first network resource block and through the transceiver.

### BRIEF DESCRIPTION OF THE DRAWINGS

FIG. 1A is a schematic view of a network system according to a first embodiment of the present invention;

FIG. 1B is a block diagram of a mobile apparatus according to the first embodiment of the present invention;

FIG. 2A is a schematic view of a network system according to a second embodiment of the present invention;

FIG. 2B is a block diagram of a mobile apparatus according to the second embodiment of the present invention;

FIG. 2C is another schematic view of a network system according to the second embodiment of the present invention;

FIG. 3 is a flowchart diagram of a random access method according to a third embodiment of the present invention;

FIG. 4 is a flowchart diagram of a random access method according to a fourth embodiment of the present invention; and

FIG. 5 is a flowchart diagram of a random access method according to a fifth embodiment of the present invention.

### DETAILED DESCRIPTION

In the following description, the present invention will be explained with reference to certain example embodiments thereof. However, these example embodiments are not intended to limit the present invention to any specific example, embodiment, environment, applications or implementations described in these example embodiments. Therefore, description of these example embodiments is only for purpose of illustration rather than to limit the present invention.

In the following embodiments and the attached drawings, elements unrelated to the present invention are omitted from depiction; and dimensional relationships among individual elements in the attached drawings are illustrated only for ease of understanding, but not to limit the actual scale.

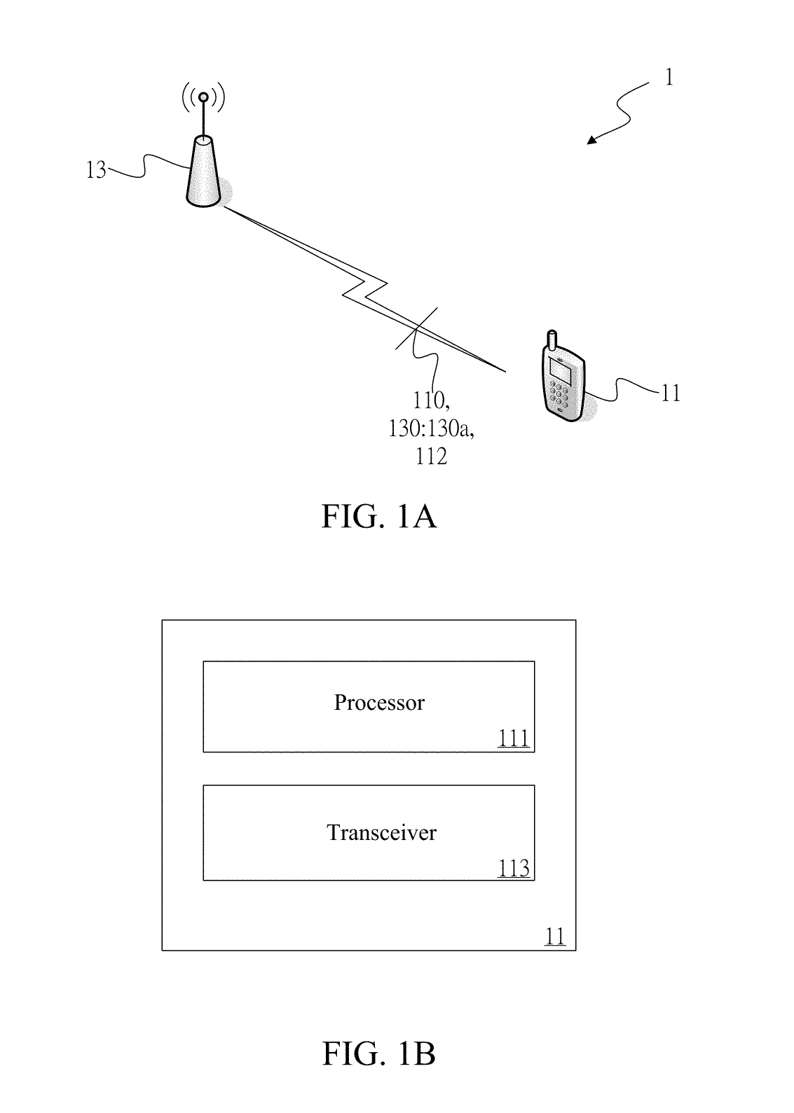

Please refer to FIG. 1A and FIG. 1B. FIG. 1A is a schematic view of a network system 1 according to a first embodiment of the present invention. The network system 1 comprises a mobile apparatus 11 and a base station 13. FIG. 1B is a block diagram of the mobile apparatus 11 according to the first embodiment of the present invention. The mobile apparatus 11 comprises a processor 111 and a transceiver 113. These elements are electrically connected together, and interactions among these elements will be further described hereinafter.

First, when the mobile apparatus 11 is going to initiate a random access procedure, the processor 111 of the mobile apparatus 11 first transmits at least two random access preambles 110 to the base station 13 via the transceiver 113. The at least two random access preambles 110 are different from each other. Accordingly, the base station 13 transmits at least two random access responses 130 respectively corresponding to the at least two random access preambles 110 back to the mobile apparatus 11 after receiving the at least two random access preambles 110.

On the other hand, the processor 111 of the mobile apparatus 11 may receive the at least two random access responses 130 corresponding to the at least two random access preambles 110 from the base station 13 via the transceiver 113. Next, the processor 111 of the mobile apparatus 11 selects a first random access response 130a from the at least two random access responses 130. The first random access response 130a indicates a first network resource block (not shown).

Thereafter, the processor 111 of the mobile apparatus 11 may transmit a wireless message 112 to the base station 13 via the first network resource block and through the transceiver 113. It shall be particularly appreciated that, the aforesaid processor 111 may select the first random access response 130a from the at least two random access responses 130 randomly. In this way, by using a plurality of random access preambles and a plurality of random access responses, the risk of message collision occurring when different mobile apparatuses use the same network resource for message transmission can be reduced.

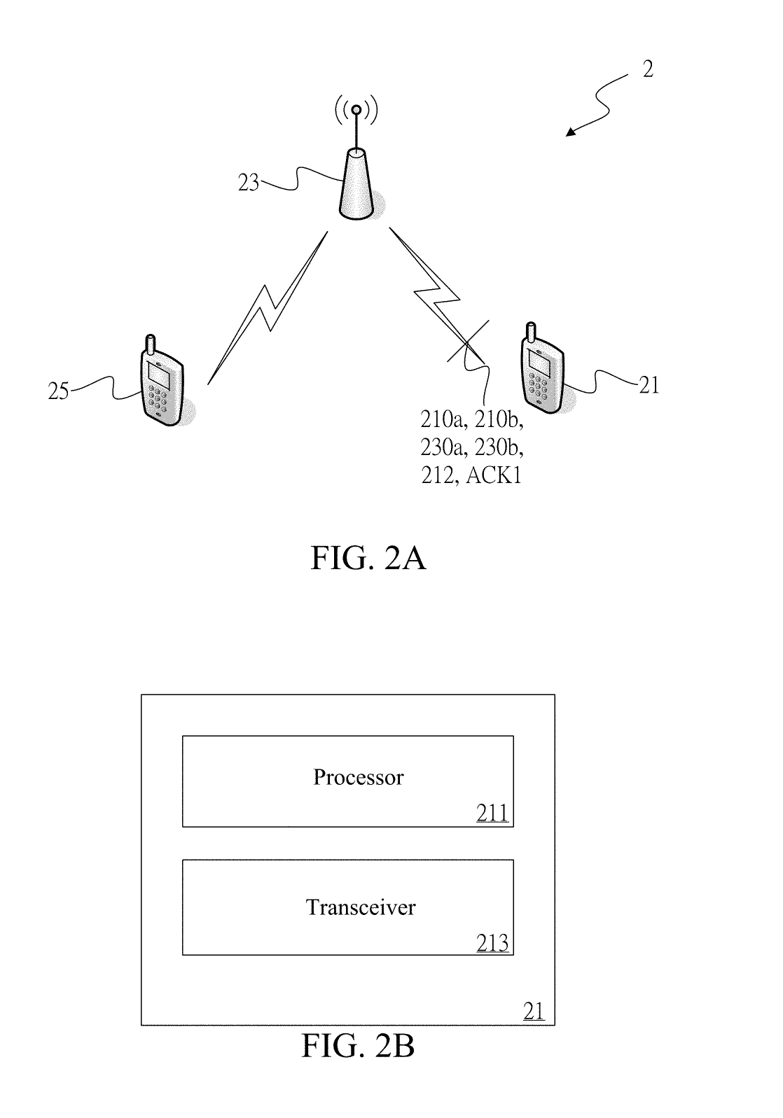

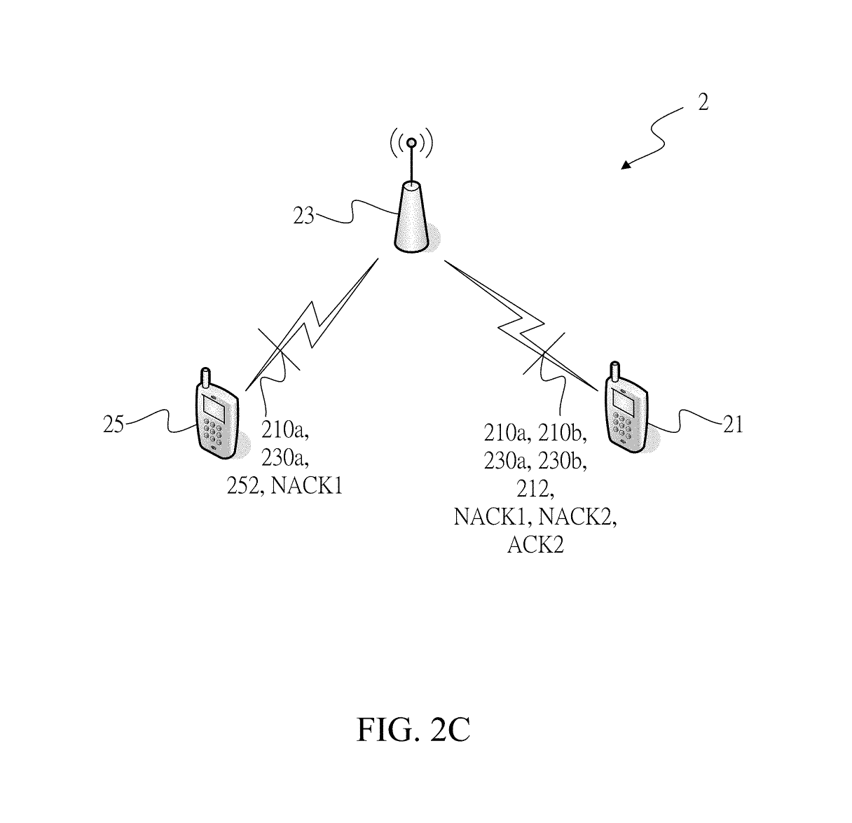

Please refer to FIG. 2A and FIG. 2B. FIG. 2A is a schematic view of a network system 2 according to a second embodiment of the present invention. The network system 2 comprises a mobile apparatus 21, a base station 23 and a mobile apparatus 25. FIG. 2B is a block diagram of the mobile apparatus 21 according to the second embodiment of the present invention. The mobile apparatus 21 comprises a processor 211 and a transceiver 213. These elements are electrically connected together. It shall be particularly appreciated that, the second embodiment mainly further illustrates random access steps of the mobile apparatus of the present invention.

First, similarly, when the mobile apparatus 21 is going to initiate a random access procedure, the processor 211 of the mobile apparatus 21 first transmits two random access preambles 210a and 210b to the base station 23 via the transceiver 213. Similarly, the random access preambles 210a and 210b are different from each other. Accordingly, the base station 23 transmits two random access responses 230a and 230b respectively corresponding to the random access preambles 210a and 210b back to the mobile apparatus 21 after receiving the random access preambles 210a and 210b.

On the other hand, the processor 211 of the mobile apparatus 21 may receive the random access responses 230a and 230b corresponding to the random access preambles 210a and 210b from the base station 23 via the transceiver 213. The random access response 230a indicates a first network resource block (not shown), and the random access response 230b indicates a second network resource block (not shown). Next, the processor 211 of the mobile apparatus 21 selects the random access response 230a from the random access responses 230a and 230b, and transmits a wireless message 212 to the base station 23 via the first network resource block indicated by the random access response 230a and through the transceiver 213.

It shall be particularly appreciated that, if no other mobile apparatus transmits the same random access preamble 210a to the base station 23, then it means that no other mobile apparatus receives the corresponding random access response 230a subsequently, and no other mobile apparatus uses the same first network resource block. Therefore, the base station 23 can correctly decode the wireless message 212 of the mobile apparatus 21 and transmit an acknowledgement (ACK) signal ACK1 indicating a reception status of the first network resource block to the mobile apparatus 21.

It should be noted that, if it is under a Long Term Evolution (LTE) network environment for example, the processor 211 of the mobile apparatus 21 can additionally perform a contention resolution procedure with the base station 23 to complete the random access procedure after receiving the acknowledgement signal ACK1 corresponding to the wireless message 212 from the base station 23. However, it is not to limit the present invention to any environment.

Please refer to FIG. 2C together, which is another schematic view of the network system 2 according to the second embodiment of the present invention. On the other hand, if the mobile apparatus 25 transmits the same random access preamble 210a to the base station 23, it means that the mobile apparatus 25 also receives the corresponding random access response 230a and also transmits a wireless message 252 to the base station 23 via the first network resource block indicated by the random access response 230a.

Therefore, the wireless message 252 of the mobile apparatus 25 will also be received by the base station 23 via the first network resource block when the wireless message 212 of the mobile apparatus 21 is received by the base station 23 via the first network resource block. As a result, collision occurs between the wireless message 212 and the wireless message 252 so that the base station 23 cannot correctly decode the wireless message 212 and the wireless message 252.

Accordingly, the base station 23 transmits a negative acknowledgement (NACK) signal NACK1 indicating a reception status of the first network resource block to the mobile apparatus 21 and the mobile apparatus 25. Meanwhile, the second network resource block is expected to be used subsequently because the base station 23 has transmitted the random access response 230b previously according to the random access preamble 210a. However, in the case where no wireless signal is received by the base station 23 in the second network resource block, the base station 23 also transmits a negative acknowledgement signal NACK2 indicating a reception status of the second network resource block.

On the other hand, because the mobile apparatus 21 has also received the random access response 230b in which the second network resource block is recoded previously, the processor 211 of the mobile apparatus 21 can also receive the negative acknowledgement signal NACK2 indicating the reception status of the second network resource block from the base station 23 via the transceiver 213 when it receives the negative acknowledgement signal NACK1 indicating the reception status of the first network resource block from the base station 23 via the transceiver 213.

Accordingly, the processor 211 of the mobile apparatus 21 retransmits the wireless message 212 to the base station 23 via the second network resource block according to the negative acknowledgement signals NACK1 and NACK2. Similarly, if no other mobile apparatus transmits the random access preamble 210b to the base station 23, then the base station 23 can correctly decode the wireless message 212 of the mobile apparatus 21 and transmit an acknowledgement signal ACK2 indicating a reception status of the second network resource block to the mobile apparatus 21.

On the other hand, the processor 211 of the mobile apparatus 21 may receive the acknowledgement signal ACK2 corresponding to the wireless message 212 from the base station 23 via the first network resource block. Similarly, if it is under an LTE network environment, a contention resolution procedure with the base station 23 can be performed optionally to complete the random access procedure after receiving the acknowledgement signal ACK2.

It shall be particularly appreciated that, in order to balance the performance and benefit of the aforesaid random access steps performed by the mobile apparatus in the aforesaid second embodiment, the processor 211 of the mobile apparatus 21 may first delay transmission of the wireless message 212 within a time period (not shown) and meanwhile monitor the usage status of available network resource blocks (e.g., the first network resource block and the second network resource block) before transmitting the wireless message 212 to the base station 23 via the first network resource block.

Additionally, in other implementations, if the mobile apparatus 21 does not directly switch to the second network resource block for retransmitting the wireless message 212 with respect to the negative acknowledgement signals NACK1 and NACK2 transmitted by the base station 23, then the base station 23 will continuously transmit the negative acknowledgement signals NACK1 and NACK2 due to message collision. In this case, the processor 211 of the mobile apparatus 21 may count a number of the negative acknowledgement signals NACK1 and NACK2.

The mobile apparatus 21 switches to the second network resource block for retransmitting the wireless message 212 only after the processor 211 determines that the number of the negative acknowledgement signals NACK1 and NACK2 reaches a threshold (not shown). The threshold may be a value set by the system. However, the threshold may also be a value generated randomly, and in this way, the probability of message collision that may occur due to the same message transmission frequency can be reduced.

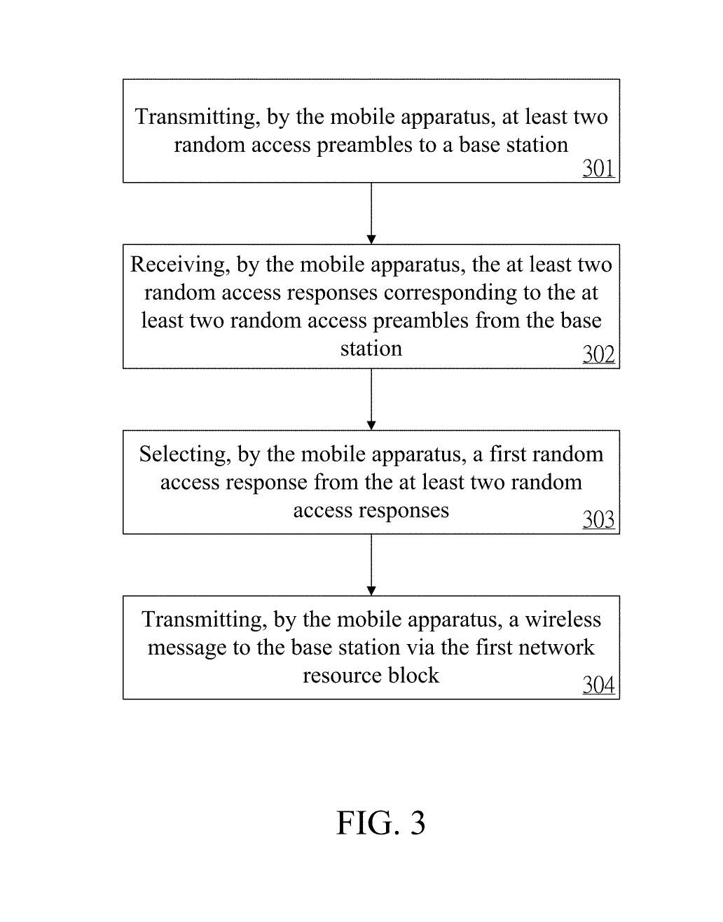

A third embodiment of the present invention is a random access method, and a flowchart diagram thereof is as shown in FIG. 3. The method of the third embodiment is for use in a mobile apparatus (e.g., the mobile apparatus of the aforesaid embodiments). Detailed steps of the third embodiment are as follows.

First, step 301 is executed to transmit, by the mobile apparatus, at least two random access preambles to a base station. Accordingly, the base station transmits at least two random access responses corresponding to the at least two random access preambles. Step 302 is executed to receive, by the mobile apparatus, the at least two random access responses corresponding to the at least two random access preambles from the base station.

Next, step 303 is executed to select, by the mobile apparatus, a first random access response from the at least two random access responses. The first random access response indicates a first network resource block. Finally, step 304 is executed to transmit, by the mobile apparatus, a wireless message to the base station via the first network resource block.

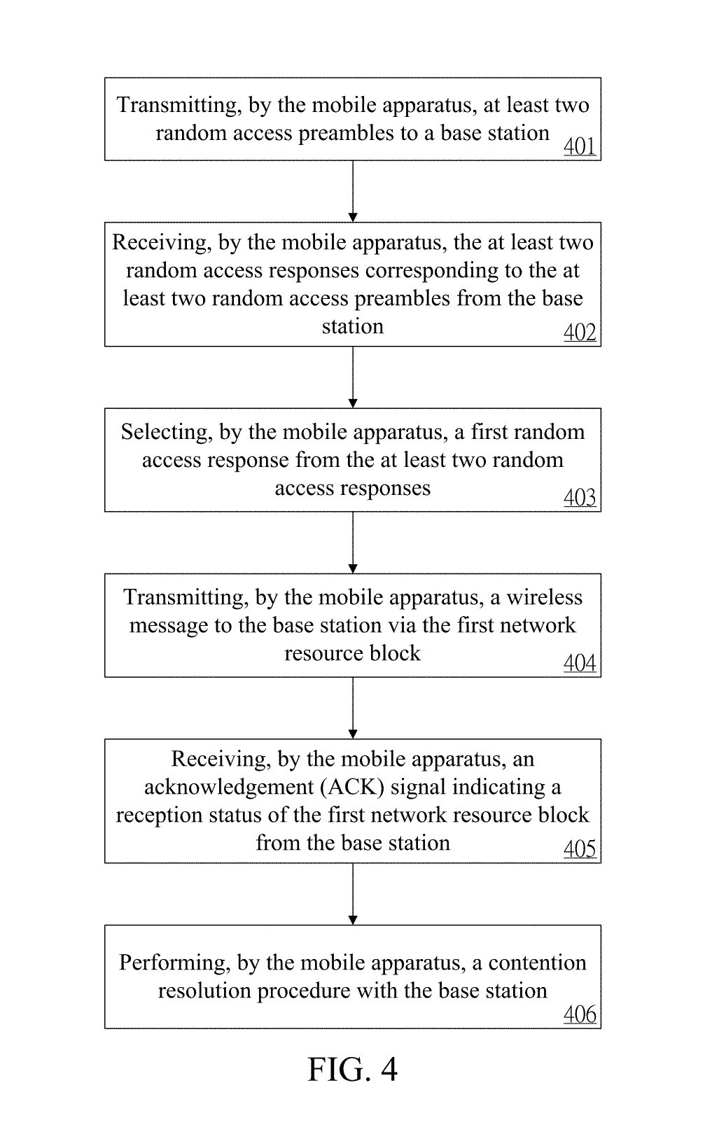

A fourth embodiment of the present invention is a random access method, and a flowchart diagram thereof is as shown in FIG. 4. The method of the fourth embodiment is for use in a mobile apparatus (e.g., the mobile apparatus of the aforesaid embodiments). Detailed steps of the fourth embodiment are as follows.

First, step 401 is executed to transmit, by the mobile apparatus, at least two random access preambles to a base station. Accordingly, the base station transmits at least two random access responses corresponding to the at least two random access preambles. Step 402 is executed to receive, by the mobile apparatus, the at least two random access responses corresponding to the at least two random access preambles from the base station. Step 403 is executed to select, by the mobile apparatus, a first random access response from the at least two random access responses. The first random access response indicates a first network resource block.

Next, step 404 is executed to transmit, by the mobile apparatus, a wireless message to the base station via the first network resource block. Step 405 is executed to receive, by the mobile apparatus, an acknowledgement (ACK) signal indicating a reception status of the first network resource block from the base station. Finally, if it is under an LTE network environment, step 406 is optionally executed to perform, by the mobile apparatus, a contention resolution procedure with the base station after receiving the ACK signal.

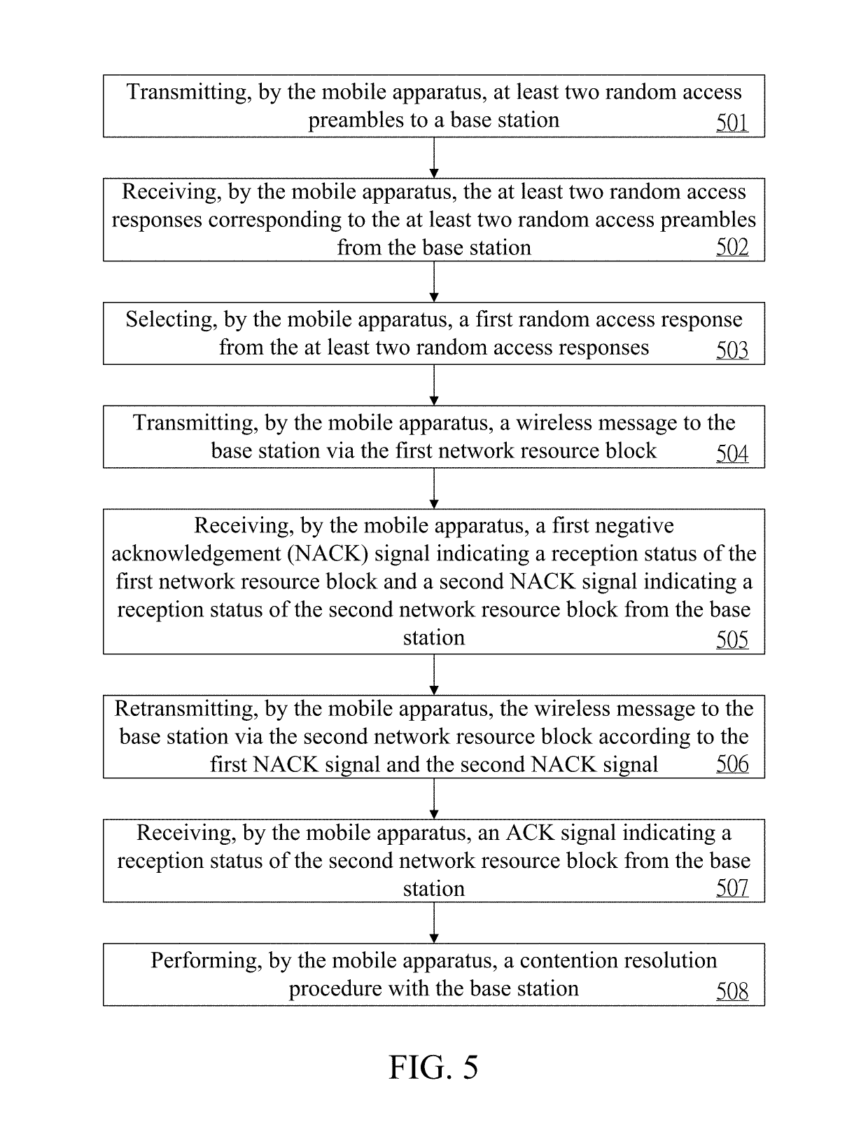

A fifth embodiment of the present invention is a random access method, and a flowchart diagram thereof is as shown in FIG. 5. The method of the fifth embodiment is for use in a mobile apparatus (e.g., the mobile apparatus of the aforesaid embodiments). Detailed steps of the fifth embodiment are as follows.

First, step 501 is executed to transmit, by the mobile apparatus, at least two random access preambles to a base station. Accordingly, the base station transmits at least two random access responses corresponding to the at least two random access preambles. Step 502 is executed to receive, by the mobile apparatus, the at least two random access responses corresponding to the at least two random access preambles from the base station. The at least two random access responses comprise a first random access response and a second random access response, the first random access response indicates a first network resource block, and the second random access response indicates a second network resource block.

Next, step 503 is executed to select, by the mobile apparatus, a first random access response from the at least two random access responses. Step 504 is executed to transmit, by the mobile apparatus, a wireless message to the base station via the first network resource block. Step 505 is executed to receive, by the mobile apparatus, a first negative acknowledgement (NACK) signal indicating a reception status of the first network resource block and a second NACK signal indicating a reception status of the second network resource block from the base station.

Next, step 506 is executed to retransmit, by the mobile apparatus, the wireless message to the base station via the second network resource block according to the first NACK signal and the second NACK signal. Step 507 is executed to receive, by the mobile apparatus, an ACK signal indicating a reception status of the second network resource block from the base station. Finally, if it is under an LTE network environment, step 508 is optionally executed to perform, by the mobile apparatus, a contention resolution procedure with the base station after receiving the ACK signal.

It shall be particularly appreciated that, implementation details of the aforesaid step 506 may be as follows: retransmitting, by the mobile apparatus, the wireless message to the base station via the second network resource block after determining that an accumulated number of the first NACK signal and the second NACK signal has reached a threshold. The threshold may be a value set by the system or a value generated randomly.

Moreover, in the embodiments of the network resource methods described above, a step of delaying, by the mobile apparatus, transmission of the wireless message within a time period may be added optionally before the step of transmitting, by the mobile apparatus, a wireless message to the base station via the network resource blocks (the first or second network resource blocks). In this way, the performance and benefit of the aforesaid random access steps performed by the mobile apparatus can be balanced.

According to the above descriptions, in the mobile apparatus and the random access method thereof according to the present invention, a plurality of random access preambles are transmitted at the same time to obtain a plurality of available network resources, and a network resource is selected randomly for wireless message transmission. In this way, the risk of collision that may occur subsequently among wireless messages can be reduced and the probability of successfully performing the random access procedure can be remarkably improved, thereby improving the utilization efficiency of the overall network resource.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A random access method for a mobile apparatus, comprising:
transmitting, by the mobile apparatus, at least two random access preambles to a base station;
receiving, by the mobile apparatus, at least two random access responses corresponding to the at least two random access preambles from the base station;
selecting, by the mobile apparatus, a first random access response from the at least two random access responses, wherein the first random access response indicates a first network resource block; and
transmitting, by the mobile apparatus, a wireless message to the base station via the first network resource block.

2. The random access method of claim 1, further comprising:
receiving, by the mobile apparatus, an acknowledgement (ACK) signal indicating a reception status of the first network resource block from the base station.

3. The random access method of claim 1, wherein the at least two random access responses further include a second random access response that indicates a second network resource block, the random access method further comprising:
receiving, by the mobile apparatus, a first negative acknowledgement (NACK) signal indicating a reception status of the first network resource block and a second NACK signal indicating a reception status of the second network resource block from the base station;
retransmitting, by the mobile apparatus, the wireless message to the base station via the second network resource block according to the first NACK signal and the second NACK signal; and
receiving, by the mobile apparatus, an ACK signal indicating a reception status of the second network resource block from the base station.

4. The random access method of claim 3, wherein the step of retransmitting, by the mobile apparatus, the wireless message to the base station via the second network resource block according to the first NACK signal and the second NACK signal further comprises:
retransmitting, by the mobile apparatus, the wireless message to the base station via the second network resource block after determining that an accumulated number of the first NACK signal and the second NACK signal has reached a threshold.

5. The random access method of claim 4, wherein the threshold is generated randomly.

6. The random access method of claim 1, further comprising the following step before the step of transmitting, by the mobile apparatus, the wireless message to the base station via the first network resource block: delaying, by the mobile apparatus, transmission of the wireless message within a time period.

7. A mobile apparatus, comprising:
a processor; and
a transceiver;
wherein the processor is configured to:
transmit at least two random access preambles to a base station through the transceiver;
receive at least two random access responses corresponding to the at least two random access preambles from the base station through the transceiver;
select a first random access response from the at least two random access responses, wherein the first random access response indicates a first network resource block; and
transmit a wireless message to the base station via the first network resource block and through the transceiver.

8. The mobile apparatus of claim 7, wherein the processor is further configured to:
receive an acknowledgement (ACK) signal indicating a reception status of the first network resource block from the base station through the transceiver.

9. The mobile apparatus of claim 7, wherein the at least two random access responses further include a second random access response that indicates a second network resource block, and the processor is further configured to:
receive a first negative acknowledgement (NACK) signal indicating a reception status of the first network resource block and a second NACK signal indicating a reception status of the second network resource block from the base station through the transceiver;
retransmit the wireless message to the base station via the second network resource block and through the transceiver according to the first NACK signal and the second NACK signal; and
receive an ACK signal indicating a reception status of the second network resource block from the base station through the transceiver.

10. The mobile apparatus of claim 9, wherein the processor is further configured to transmit the wireless message to the base station via the second network resource block and through the transceiver after determining that an accumulated number of the first NACK signal and the second NACK signal has reached a threshold.

11. The mobile apparatus of claim 10, wherein the threshold is generated randomly.

12. The mobile apparatus of claim 7, wherein the processor is further configured to execute the following operation before transmitting the wireless message to the base station via the first network resource block:
delay transmission of the wireless message within a time period.
